(19) United States
(12) Patent Application Publication
(10) Pub. No.: US 2003/0065497 A1
(43) Pub. Date: Apr. 3, 2003

(54) Power management system to select a power state for a network computer system based on load

(76) Inventor: Monte J. Rhoads, Hillsboro, OR (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/967,032

(22) Filed: Sep. 28, 2001

(51) Int. Cl. G06F 17/50

(52) U.S. Cl. 703/18

(57) ABSTRACT

A power state selection system and method are described to receive a representation of a network processing load associated with a plurality of network access devices, to select a power state based on the representation, and to assert a power state selection signal corresponding to the selected power state.

### COPYRIGHT NOTICE

Contained herein is material that is subject to copyright protection. The copyright owner has no objection to the facsimile reproduction by anyone of the patent document or the patent disclosure, as it appears in the United States patent and Trademark Office patent file or records, but otherwise reserves all rights to the copyright whatsoever. The following notice applies to the software and data as described below and in the drawings hereto: Copyright © 2001, Intel Corporation, All Rights Reserved.

### BACKGROUND OF THE INVENTION

### FIELD OF THE INVENTION

The invention relates generally to the field of power management for networked electronic devices. More particularly, the invention relates to a system and method for selecting a power consuming state for a network computer system based on a network load.

### BACKGROUND INFORMATION

Many laptop personal computers are able to operate in a plugged-in outlet-powered mode wherein power is supplied by a reliable and sufficiently unlimited source of outlet power, and in an un-plugged battery-powered mode wherein power is supplied by a battery having finite stored energy. Typically, the laptop's processor and other electrical components consume enough power to deplete the energy stored in the battery within several hours of use. In order to increase the number of hours that the laptop may operate on battery power, battery utilization systems have recently been developed that allow the laptop to operate in reduced performance power states during periods when power is supplied by the battery.

FIG. 1 illustrates a mobile laptop personal computer 100 that incorporates a power supply/battery utilization system 110 comprising intelligence to place a mobile laptop processor 150 in a first performance mode 160 or a second performance mode 170 based on whether the mobile laptop personal computer 100 is receiving power from an AC power source 120 and power supply 130 or a battery 140. In particular, the intelligence comprises intelligence to determine when the mobile laptop personal computer 100 is connected with the AC power source 120 via a de-attachable power cord 125 and at such times to place the mobile laptop processor 150 in the first full performance mode 160, and the intelligence comprises intelligence to determine when the mobile laptop personal computer 100 is not connected with the AC power source 120 and is using battery power and at such times to place the mobile laptop processor 150 in the second reduced performance mode 170.

Several such power supply/battery utilization systems 110 are available for mobile laptop personal computers 100. For example, Intel Corporation of Santa Clara, Calif., offers Enhanced Intel® SpeedStep™ Technology to place a Mobile Intel® Pentium® III Processor-M in either a first performance mode 160 comprising a first core operating frequency and voltage, or a second performance mode 170 comprising a second core operating frequency and voltage for use in a mobile laptop personal computer 100, such as a Dell Inspiron 8100 series notebook (available from Dell Corporation of Austin, Tex.). Enhanced Intel® SpeedStep™ Technology incorporates the Advanced Configuration And Power Interface (ACPI) specification. ACPI describes ways that an operating system may implement a power state on the mobile laptop processor 150, and is well known to those having an ordinary level of skill in the art. ACPI specification version 2.0 is available from Intel Corporation, and available at www.teleport.com/˜acpi/. Alternatively, AMD Corporation of Sunnyvale, Calif. offers AMD PowerNow!™ technology to place an AMD Athalon™ 4 processor 150 into different power modes. Also, Transmeta Corporation of Santa Clara, Calif. offers LongRun™ power management technology to place Transmeta's Crusoe™ processor in different power modes.

Such power supply/battery utilization systems 110 provide a way to use a mobile laptop personal computer 100 for prolonged periods of time when operating on battery power by operating at reduced performance levels that consume less power. However, these systems 110 provide power management intelligence that is limited to mobile laptop personal computers 100 that derive power alternatively from an AC source 120 or a battery 140.

### BRIEF DESCRIPTION OF THE SEVERAL VIEWS OF THE DRAWINGS

The novel features believed characteristic of the invention are set forth in the appended claims. The present invention is illustrated by way of example, and not by way of limitation, in the figures of the accompanying drawings and in which like reference numerals refer to similar elements. The invention itself, however, as well as a preferred mode of use, will best be understood by reference to the following detailed description of an illustrative embodiment when read in conjunction with the accompanying drawings:

FIG. 1 illustrates a mobile laptop personal computer that incorporates a power supply/battery utilization system.

FIG. 2 illustrates simplified system architecture, according to one embodiment.

FIG. 3 illustrates a method for operating a network computer system, according to one embodiment.

FIG. 4A and 4B illustrate a method for operating a network computer system including selecting and implementing different power states, according to one embodiment.

FIG. 5 illustrates a method for operating a power state selection system, according to one embodiment.

FIG. 6 illustrates system architecture of a power state selection system, according to one embodiment.

FIG. 7 illustrates a method for maintaining a network load representation, according to one embodiment.

FIG. 8 illustrates variation in client connections to a Web server throughout a day, according to one embodiment.

FIG. 9 illustrates system architecture for a server power management system, according to one embodiment.

FIG. 10 illustrates a graphical user interface to make power state selection settings, according to one embodiment.

FIG. 11 illustrates a computer system upon which one embodiment may be implemented.

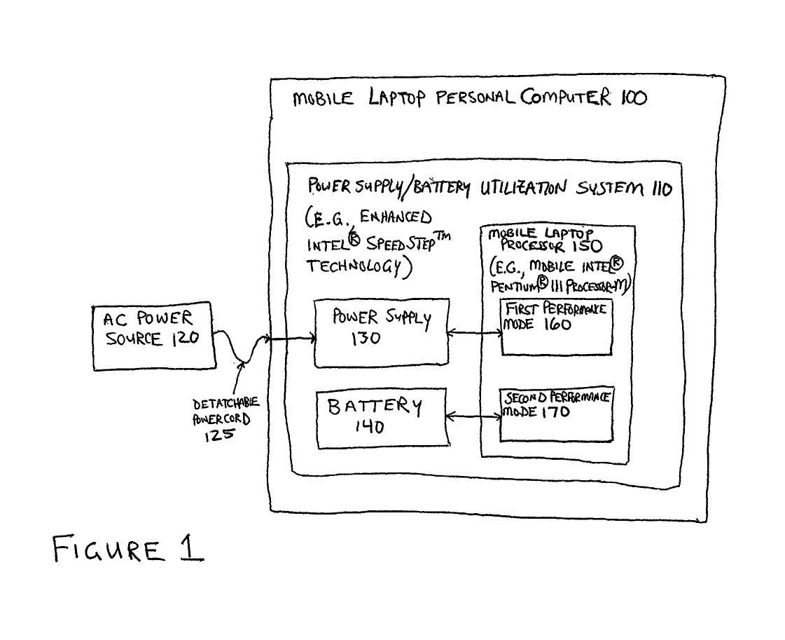

### DETAILED DESCRIPTION OF THE INVENTION

In the following description, for the purpose of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

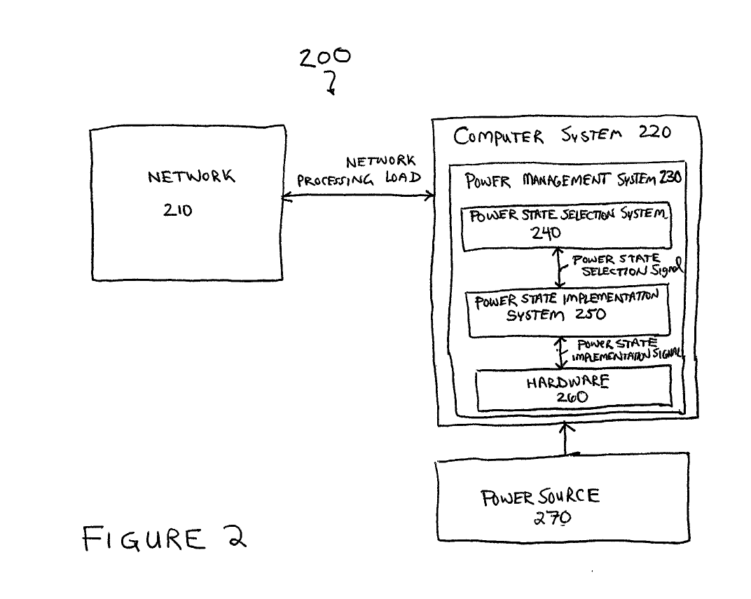

FIG. 2 illustrates a simplified block diagram of system architecture 200 of one embodiment of the invention. The system 200 includes a network 210, a computer system 220 connected with the network 210 to receive a network processing load from the network, a power management system 230 to provide a plurality of different power consuming states for the computer system 220 based on the network processing load, and a power source 270 to provide an amount of power that depends on the power state to the computer system 220 to allow it to operate.

According to one embodiment, the power management system 230 comprises a power state selection system 240, a power state implementation system 250 functionally coupled with the selection system 240, and hardware 260 functionally coupled with the implementation system 250. The power state selection system 240 receives at least a representation of the network processing load, selects a power state based on the representation, and asserts a power state selection signal corresponding to the selected power state. The power state implementation system 250 receives the power state selection signal and asserts a corresponding power state implementation signal. The hardware 260 receives the power state implementation signal, switches to the power state indicated by the power state implementation signal, and performs power consuming electronic operations at the asserted power state.

Different embodiments of the network 210 are contemplated. In a broad embodiment, the network 210 may comprise a plurality of potentially heterogeneous electronic network access devices (e.g., personal computers, workstations, servers, wireless devices, personal digital assistance (PDAs), cell phones) that are functionally connected with the computer system 220 via a potentially heterogeneous and arbitrarily complex data transmission medium that may include any one or more conventional network architectures and components. In another broad embodiment, the network 210 may comprise any network architecture or component that allows the electronic devices to interact with the computer system 220 and provide the network processing load to the computer system 220. In a specific embodiment, the network 210 may comprise a personal computer client equipped with a browser to access the computer system 220 via an Internet Service Provider and the Internet. In the same or another embodiment, the network 210 may comprise a wireless device (e.g., a cellular phone) comprising a microbrowser to access the computer system 220 via a wireless network, a wireless gateway, and the Internet. Alternatively, as will be well understood by a person having an ordinary level of skill in the art based on the present teachings, other network architectures and components are contemplated including Internet and non-Internet architectures and components, such as satellite, wireless, cellular, cable, local area, wide area, and metropolitan area network architectures and components.

The network 210 provides the network processing load. Different embodiments of the network processing load are contemplated. In a broad embodiment, the network processing load may comprise an interaction between an electronic device associated with the network 210 and the computer system 220. The network processing load may comprise a connection-oriented message delivery processing load, as in the case of telephone, TCP, and HTTP protocols, or a connectionless message delivery processing load, as in the case of Ethernet, IPX, and UDP protocols, and a processing load associated with the message. In a more specific connection-oriented embodiment the network processing load may comprise a plurality of TCP/IP connections, each connection including processing load portions to perform exemplary operations such as one or more of maintaining the connection, performing a handshake, exchanging encrypted data (e.g., Secure Sockets Layer), performing decryption, manipulating the decrypted data, accessing relevant data from a data source, running a database management system, dynamically interacting as a result of the connection, performing server-side dynamic processing (e.g., using Common Gateway Interface (CGI) scripts to process user entered data submitted via an HTML form, running Java servlets, or running Internet Server APIs), providing client-side dynamic processing (e.g., providing Java applets, Java scripts, or ActiveX controls), providing multimedia data, providing real-time multimedia chat, sending faxes, performing file transfer protocol, providing text based Internet Relay Chat, providing e-mail response, providing messaging systems, providing news delivery, providing Telnet, formatting data, and terminating a connection.

The computer system 220 receives the network processing load through a network interface, such as a network interface card (NIC). Different embodiments of the computer system 220 are contemplated. In a broad embodiment, the computer system 220 may be any computer system to receive a network load, to select a power state based on the network load, and to perform power consuming electronic operations that are associated with the load at the selected power state. In a more specific embodiment, the computer system 220 may comprise a server to receive network requests from the network 210, a power state selection system 240 to select a power state for at least one processor based on the request (and likely other requests), a power state implementation system 250 to implement the selected power state, a processor to switch to the implemented power state and to execute responsive operations associated with the request. The server may be a rack mount server, a modular server, or a compact PCI compute blade, and may comprise a plurality of processors that each comprise a plurality of operational power states. In one embodiment, the server comprises a desktop or laptop motherboard and a mobile laptop processor, such as a Mobile Intel® Pentium® III Processor-M.

The power state selection system 240 receives at least a representation of the network processing load. Different embodiments of the representation are contemplated. Broadly, the representation may comprise power state stimulus information or power management event information operable to cause the power state selection system 240 to select a power state.

According to a first embodiment, the representation comprises the actual network processing load. In such an embodiment, the system 240 may examine the network processing load including number of packets received and sent and use this bandwidth information as a representation of processing load.

According to a second embodiment, the representation may comprise any information that describes or indicates a magnitude or type of the network processing load. The representation may be received from the network, may be provided by an operating system or network monitoring program, or may be otherwise obtained. The representation may comprise information indicating a percentage of a maximum network processing load, a percentage of an average processing load, a user or application desire that the load be processed expediently, a number of active network connections, a percentage of connections of a first type (e.g., wired instead of wireless), a different type of transaction (e.g., secure versus un-secure), a number of files to be served, a number of CGI processes to execute, a number of Java servlets to run, a number of Java applets to provide, and other indications desired to represent the network processing load for purposes of selecting a power state.

Consider without limitation an exemplary representation that comprises connection and termination requests that a power state selection system 240 may use to maintain an active connection count. Based on this count, which may estimate load on a processor, the selection system 240 may select a power state. This simple representation may be useful for certain implementations, especially when each connection contributes a substantially similar load to the processor. However, in some instances some connections may contribute different loads to the processor. For example, a single secured encryption may contribute the same load to the processor as hundreds of non-secured connections. Accordingly, some representations may comprise information indicating a type of connection (e.g., secured rather than unsecured).

According to a third embodiment, the representation may comprise an affect of the processing load on the hardware 260. The hardware 260 may provide feedback or other indications to the power state selection system 240 to indicate how active or idle the hardware 260 is as a result of the received network load. For example, a processor may provide information, such as recent processor activity, number of instructions executed in a predetermined time interval, processor temperature, or other indicative information.

According to a fourth embodiment, the representation may comprise a time from a time keeping logic device. The power state selection system 240 may receive the time and compare the time with a threshold time to select a power state. For example, the power state selection system 240 may comprise logic to select a reduced power state by comparing a time of 11:00 PM with a 11:00 PM threshold to enter a low power state due to reduced performance expectations at late night.

Different power state selection systems 240 are contemplated. In a broad embodiment, the power state selection system 240 may comprise software logic, hardware logic, or some combination to select a power state based on the network processing load that may be consistent with or appropriate for the load. In a more specific embodiment, the system 240 may comprise stored predetermined power state thresholds and software power state selection instructions to compare at least a representation of the network load with the thresholds and select a power state based on the comparison.

Consider without limitation the following exemplary power state selection system 240 that selects a lower power state for the computer system 220. First, the selection system 240 receives an indication of a load, then accesses a preprogrammed threshold, then compares the representation with the threshold, then determines that the representation is below the threshold, then selects a low power state, then determines that the selected state is different than the current power state, then generates a power state selection signal indicating the selected low power state, and then asserts the selection signal. Other embodiments are contemplated.

The power state selection system 240 asserts a power state selection signal. Different power state selection signals are contemplated. According to one embodiment, the power state selection signal uniquely identifies a power state of the hardware 260. For example, the signal may identify a predetermined power state of a processor. According to another embodiment, the selection signal is based on a power management protocol or specification, such as a current and future ACPI specification. For example, the selection signal may mimic a signal or indication issued when a mobile laptop personal computer that supports Intel® SpeedStep™ Technology or Enhanced Intel® SpeedStep™ Technology is made to enter maximum performance mode or battery powered mode. According to one embodiment, the power state selection signal comprises a voltage indication on a pin that is coupled with a motherboard and a processor. For example, the power state selection signal may be voltage indication on an existing pin of a mobile laptop motherboard in use as a mobile laptop personal computer would receive a voltage indication from an external power source when the mobile laptop personal computer was receiving power from the external power source.

The power state implementation system 250 receives the power state selection signal and asserts a power state implementation signal to the hardware 260. Different power state implementation systems 250 are contemplated. In a broad embodiment, the implementation system 250 acts as an intermediary between the selection system 240 and the hardware 260 to allow a power state selection signal that would not be intelligible to the hardware 260 to implement a power state corresponding to the selection signal via the power state implementation signal. The implementation system 250 may comprise logic to translate a typically simple hardware-unintelligible power state selection signal into a typically sophisticated hardware intelligible power state implementation signal, which may comprise a plurality of signals. According to a more specific embodiment, the power state implementation system 250 may be based on a current or future ACPI specification. For example, the implementation system 250 may comprise a chipset, BIOS, voltage regulator, and operating system that support Intel® SpeedStep™ Technology, Enhanced Intel® SpeedStep™ Technology or both.

Different power state implementation signals are contemplated. According to one embodiment, the power state implementation signal is a conventional power state implementation signal that corresponds to a conventional processor. For example, in one specific embodiment, the power state implementation signal comprises the Intel® SpeedStep™ Technology operating mode selection GHI# signal.

The hardware 260 receives the power state implementation signal, switches to the implemented power state and operates at the implemented power state. According to one embodiment, the hardware 260 comprises all of the power consuming electronic circuitry of the computer system 220 or any desired subset thereof. For example, the hardware 260 may comprise a chipset, a processor, a memory device, a mass storage device, and other components.

The power source 270 provides power to the computer system 220 based on the amount of power consumed by the hardware 260. According to one embodiment, the power source 270 comprises a conventional server power source. For example, the power source 270 may comprise a DC power source, an AC power source, an uninterrupted power supply (UPS), a generator, or other power sources that are desired for the particular implementation.

In this way, the power management system 230 may select and implement different power consuming states for the computer system 220 based on network processing load information. Advantageously, this may allow the computer system 220 to conserve costly power by using an appropriate amount of power to accomplish the tasks provided by the network 210.

Although embodiments of the invention will frequently be described in terms of power consumption and power consuming states, embodiments may be based on performance and performance states. For example, in one embodiment the computer system 220, a processor of the computer system 220, or both may have a high power consuming state that corresponds to a high performance (e.g., high clock rate) state and a low power consuming state that corresponds to a low performance (e.g., low clock rate) state.

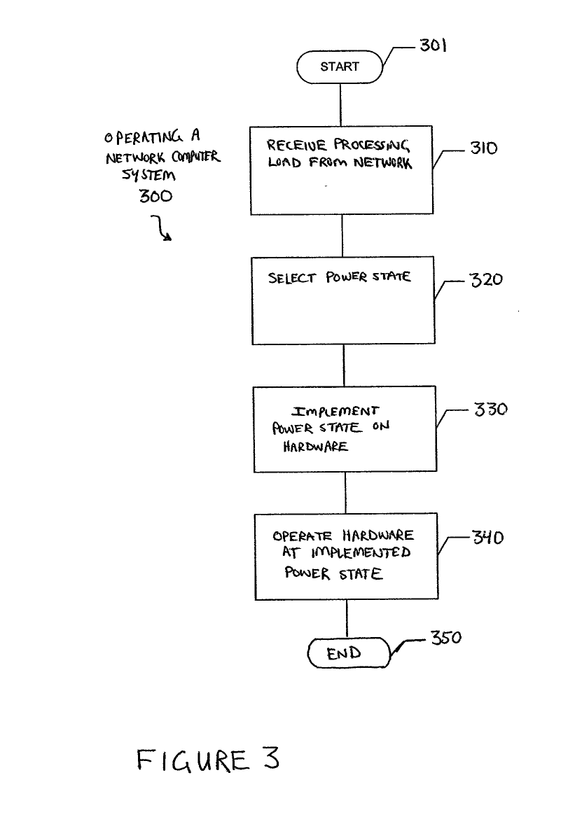

FIG. 3 illustrate a method 300 for operating a network computer system such as a server, according to a first embodiment. The method 300 may be implemented in logic that may include software, hardware or a combination of software and hardware. The method 300 commences at block 301 and then proceeds to block 310 where a processing load is received from a network. The method 300 advances to block 320 where a power state is selected based on at least a representation of the load. The method 300 advances to block 330 where the power state is implemented on hardware. The method 300 advances to block 340 where the hardware is operated at the implemented power state and consumes an amount of power that corresponds to the power state. The method 300 terminates at block 350.

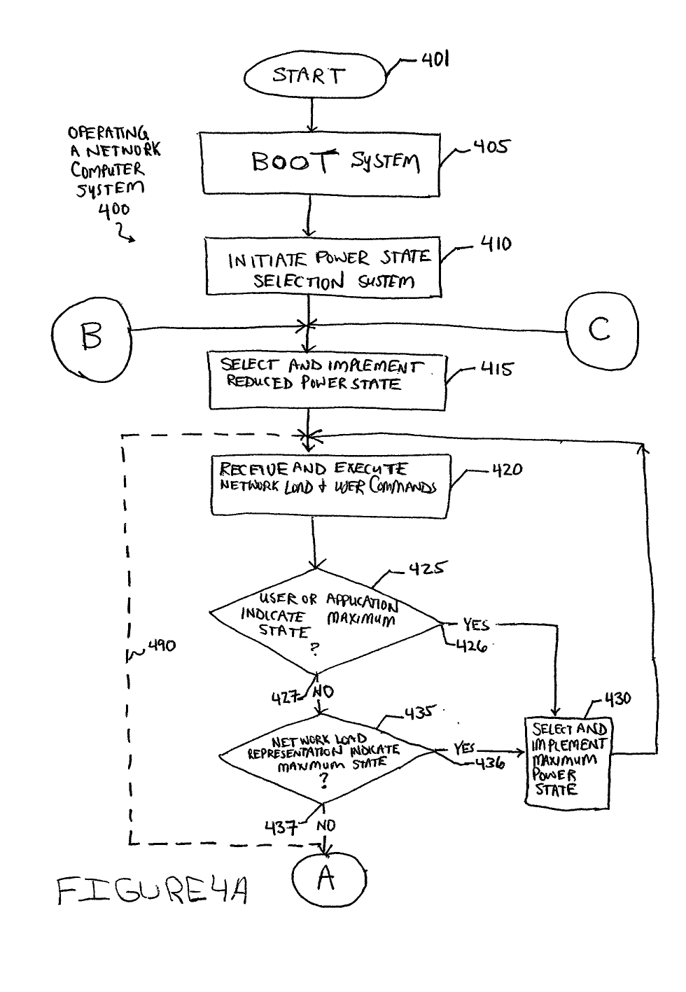

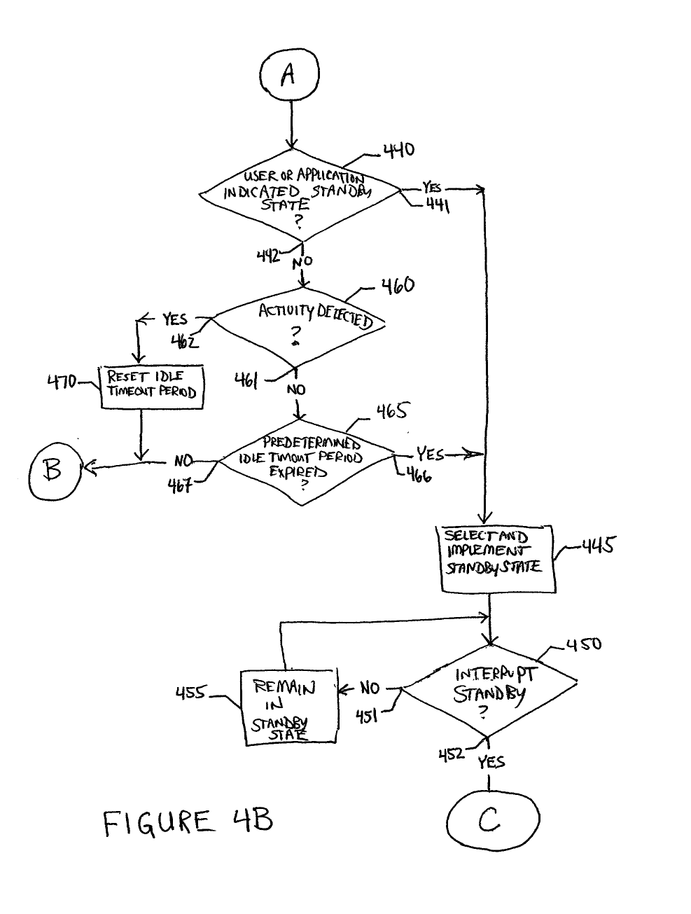

FIGS. 4A and 4B illustrate a method 400 for operating a network computer system such as a server, according to a second embodiment (blocks A, B, and C show transitions between FIGS. 4A and 4B). The method 400 may be implemented in logic that may include software, hardware or a combination of software and hardware.

The method 400 commences at block 401, and then proceeds to block 405, where a computer system, such as computer system 220 or another computer system, begins operation from an off power level by performing a cold boot. During a cold boot the computer system initializes memory components and resets various system components once computer system power is at a stable operating level. This initialization and reset places system components in a known and synchronized operating state. After initialization and reset the BIOS and operating system may be loaded into main memory.

The method 400 advances from block 405 to block 410 where the power state selection system is initiated. This may include loading instructions into main memory and beginning to initiating execution of instructions.

The method 400 advances from block 410 to block 415 where a reduced power state is selected and implemented. Advantageously, this may allow the computer system to initially assume a low power consumption state until a determination that a higher power consumption state is desired. However another embodiment contemplates the use of a maximum power state.

The method 400 advances from block 415 to block 420 where load is received from a network and user commands are received via a data entry device and the load and commands are executed using the low power state. The load may be from network 210 or another network and may comprise a combined processing load from multiple network access devices performing requests as clients to a server.

The method 400 advances from block 420 to decision block 425. A determination is made at decision block 425 whether a user has indicated a maximum power state or an authorized application has indicated a maximum power state. This may include determining whether a user has altered a physical manual override or made a selection via a graphical user interface (GUI) provided for the power state selection system. This may also include determining whether an application desires a different power state, such as through a procedure call. If yes is the determination 426 then the method 400 advances to block 430 where the maximum power state is selected and implemented and the method 400 revisits block 420. If no is the determination 427 then the method 400 advances to decision block 435.

A determination is made at decision block 435 whether a network load representation indicates a maximum power state. Considering an embodiment in which the network load representation includes information indicating a number of client connections, this determination may include comparing the indicated number with a stored lower boundary client connection threshold representing the lowest number of client connections that are to be used for the maximum power state. If yes is the determination 436 then the method 400 advances to block 430 where the maximum power state is selected and implemented and the method 400 revisits block 420. If no is the determination 437 then the method 400 advances to decision block 440, as shown by the block A.

A determination is made at decision block 440 whether a user or application has indicated a standby power state. Standby power state refers to a significantly reduced non-executing power state in which power consumption is very small. Power is supplied to components and they may generate interrupts that allow transitioning out of the standby mode and waking the processor. Active applications remain in main memory and transition to a higher power consuming executing state may be performed without reloading applications. Thus waking from this state may be performed with only minor delays. This may include determining whether a user has activated a physical or software indication of the standby power mode. If yes is the determination 441 then the method 400 advances to block 445 where the standby power state is selected and implemented. If no is the determination 442 then the method 400 advances to decision block 460.

A determination is made at decision block 460 whether activity is detected. According to a first embodiment, this may include determining whether network load is received. According to a second embodiment, this may include determining whether the processor is executing operations. If no is the determination 461 then the method 400 advances to decision block 465. If yes is the determination 462 then the method 400 advances to block 470 where an idle timeout period is reset and the method 400 revisits block 415 (as shown by block B) where the reduced power state is selected and implemented.

The method 400 advances from a no decision 461 to block 465 where a determination is made whether a predetermined idle timeout period has expired. The timeout period may be selected to be convenient for the particular implementation. If yes is the determination 466 then the method 400 advances to block 445 where the standby power state is selected and implemented. If no is the determination 467 then the method 400 revisits block 415 (as shown by block B) where the reduced power state is selected and implemented.

As stated above, the method 400 may advance to block 445 where the standby power state is selected and implemented through a yes determination 441 or a yes determination 466. The method 400 advances from block 445 to block 450 where a determination is made whether a standby interrupt occurs. According to one embodiment the power state selection system may cause an interrupt based on received network load. Other system interrupts and conventional interrupts are contemplated. If no is the determination 451 then the method 400 advances to block 455 where the standby state is maintained and the method revisits block 450. If yes is the determination 452 then the method 400 revisits block 415 (as shown by block C) where the reduced power state is selected and implemented and processing resumes in the reduced power state.

Other methods for operating network computer systems such as servers are also contemplated. According to one embodiment a method comprises placing a server in a high performance, high power consumption mode based on a representation of high network load and a low performance, low power consumption mode based on a representation of low network load without provisions for selecting a standby mode. For example, without limitation, a method may comprise a modification of method 400 such that following a no determination 437 the modified method 400 may revisit block 420 as indicated by dashed line 490 or terminate at block A. In this and other ways a network computer system or server may be operated without automatic selection of standby modes by a power state selection system, which may be desirable for certain implementations.

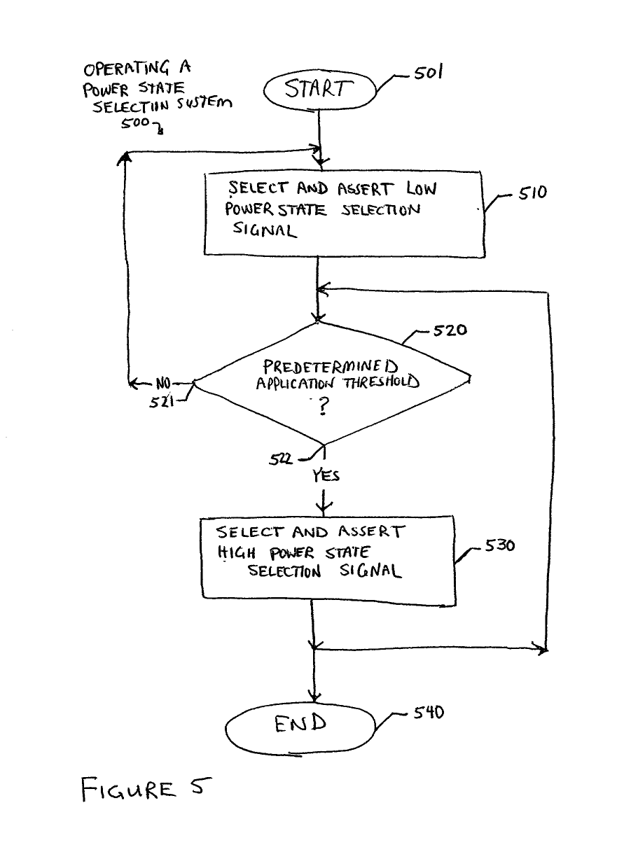

FIG. 5 illustrate in block diagram form a method 500, according to one embodiment, for operating a power state selection system, such as power state selection system 240 or another. The method 500 may be implemented in logic comprising software, hardware or a combination of software and hardware.

The method 500 commences at block 501 and then proceeds to block 510 where a low power state selection signal is selected and asserted. This may include accessing or generating an instruction or other unambiguous representation of the low power state and providing or communicating the instruction or representation. The method 500 advances to decision block 520 where a determination is made whether a predetermined application threshold has been reached. The determination may comprise comparing an application load that varies in real time based on interactions with the network with a predetermined and preprogrammed application threshold to determine on what side of the predetermined application threshold the application load lays. The application load may represent network activity, instantaneous load received from the network, processor activity, or other application loads. If no is the determination 521 then the method 500 revisits block 510 where a low power state is selected and asserted. If yes is the determination 522 then the method 400 advances to block 530 where a high power state is selected and asserted. From block 530 the method 500 may revisit determination block 520 or terminate at block 540, as desired.

Different embodiments of the method 500 are contemplated. For example, in one embodiment, the selection system selects and asserts a high power state at block 510, and thereafter determines at decision block 520 that the network load has fallen below a threshold, and thereafter selects and asserts a low power state at block 530. Additionally, according to another embodiment, the method 500 incorporates a delay. This delay may avoid rapid thrashing between selections at blocks 510 and 530 if the representation is comparable in magnitude to a threshold and moving back and forth across the threshold. For example, a delay may be implemented so that the determination 520 is performed every few seconds or every few minutes.

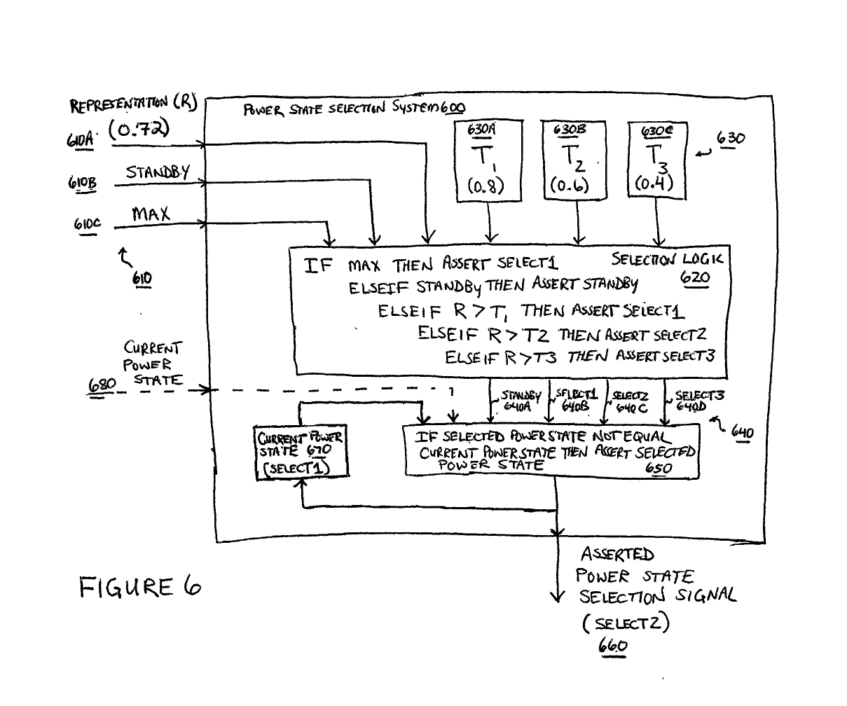

FIG. 6 is a simplified block diagram of the system architecture of a power state selection system 600 of one embodiment. The power state selection system 600 may be implemented in logic comprising software, hardware, or a combination of software and hardware, as desired for the particular implementation.

The selection system 600 comprises an interface, such as an Application Programming Interface (API) in the case of software, to receive a plurality of power state indication signals 610. The power state indication signals 610 comprise a representation of a network processing load (R) signal 610A, a standby signal 610B, and a max signal 610C. According to one embodiment, an authorized user, application, or computer system component may provide the signals 610. According to a first embodiment the representation 610A may comprise network bandwidth information. According to a second embodiment the representation 610A may comprise network management information from an operating system or network monitoring application. According to a third embodiment the representation 610A may comprise connection count information. According to a fourth embodiment the representation 610A may comprise information indicating activity of a processor. According to a fifth embodiment the representation 610A may comprise current time information. The signals 610B and 610C may be override signals that an authorized user, application, or system component may use to control how the power state selection system 600 selects a power state.

The signals 610 and a plurality of predetermined and preprogrammed application thresholds 630 are provided to selection logic 620. The thresholds 630 comprise first threshold (T1) 630A, a second threshold (T2) 630B, and a third threshold (T3) 630C. The logic 620 may comprise instructions to select a predetermined power state based on the signals 610 and the thresholds 630.

An exemplary set of logic is shown, without limitation, to illustrate how a simple power state selection may be performed and an internal selection signal 640 may be asserted. This exemplary logic gives primary control to the override signals 610B and 610C. If signal 610C is asserted then the maximum power state is selected and the select1 signal 640B is asserted. Conversely, if signal 610C is not asserted but signal 610B is asserted then the standby power state is selected and the standby signal 640A is asserted. If neither of signals 610B and 610C are asserted then the selection is based on the asserted representation 610A. If the representation is larger than the threshold 630A then the maximum power state is selected and select1 640B is asserted. Alternatively, if the representation is not larger than threshold 630A but is larger than threshold 630B then a lower power state is selected and select2 640C is asserted. However, if the representation is not larger than threshold 630A or threshold 630B but is larger than threshold 630C then a still lower power state is selected and the select3 signal 640D is asserted.

The asserted signal 640 is provided to logic 650 to avoid asserting an unnecessary power state selection signal. The logic 650 also receives an indication of the current power state either from a current power state storage 670 or from a current power state signal 680 from hardware (e.g., a processor). If the selected and asserted power state 640 is not equal to the current power state 670 (or 680) then the selected and asserted power state 640 is asserted externally as an asserted power state selection signal 660.

Consider without limitation the following example. The signals 610B and 610C are not asserted and the representation 610A has a value of 0.72. The representation 610A is compared with a first threshold 630A having a value of 0.80 and a second threshold 630B having a value of 0.60 at which point a power state is selected and the corresponding select2 signal 640C is asserted. The asserted select2 signal 640C is received by logic 650 along with an indication that the current power state is select1 from 670. Accordingly, the selected power state (select2) is different than the current power state (select1) and the power state selection signal select2 is asserted 660.

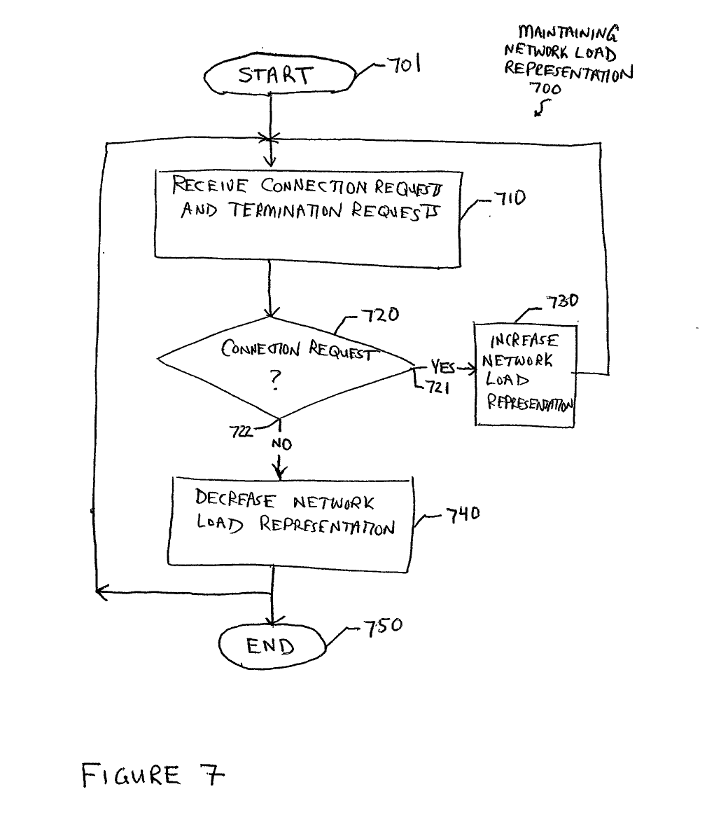

FIG. 7 illustrate in block diagram form a method 700, according to one embodiment, for maintaining a network load representation. According to one embodiment the method 700 may be implemented by a power state selection system, such as selector 240, or by another application, such as a network monitoring application.

The method 700 commences at block 701 and then proceeds to block 710 where connection requests and termination requests are received. These may be client TCP requests from potentially heterogeneous network access devices. The method 700 advances from block 710 to decision block 720 where a determination is made whether the received request is a connection request. According to one embodiment a connection request may be determined when a SYN packet is received. If yes is the determination 721 then the method 700 advances to block 730 where a network load representation is increased. If the connection request is the first connection request then the representation may be increased from substantially zero, otherwise the representation may be increased from a previous value. From block 730 the method 700 revisits block 710. If no was the determination 722 the method 700 advances to block 740 where the network load representation is decreased. From block 740 the method 700 may revisit block 710 or may terminate at block 750, as desired.

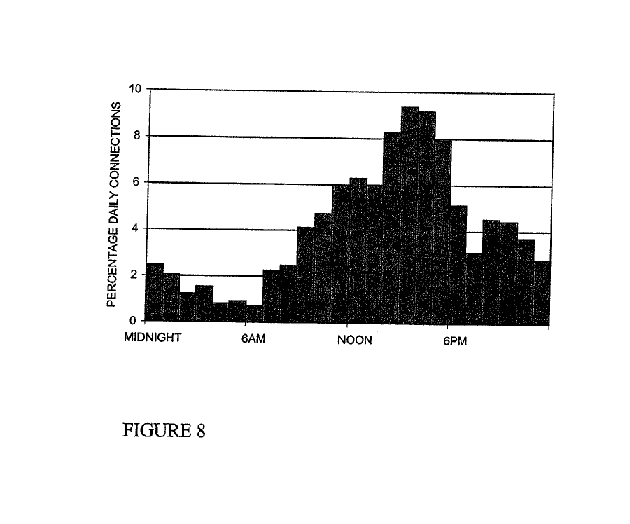

The number of client connections to a Web server may vary significantly during a day due to client use patterns. FIG. 8 shows, without limitation, a substantially predetermined and typical pattern of user connections to a Web server during the course of a day. The y-axis shows percentage of total daily connections for each of 24 hourly bars of the x-axis. The sum of y-values for each of the 24 bars totals 100%. Starting at midnight the number of connections may decrease until about 7:00 AM when the number of connections begins to increase towards a maximum that occurs at around 4:00 PM and then slowly decreases back to the midnight value. Other patterns are contemplated.

According to one embodiment, a substantially predetermined historical pattern of performance expectations for a server, and time thresholds related thereto, may be used to select a power state for the server that is appropriate for the historical performance expectations for the server. A high power state may be selected at a predetermined time when high server performance is expected and a low power state may be selected at a predetermined time when low server performance is expected. This may allow reduction of power consumption during times when maximum performance is not expected or needed from the server. For example, considering the pattern of FIG. 8, a selection system may select according to logic such as: if the current time is 10:00 PM then select a low power consuming state; and if the current time is 7:00 AM then select a high power state. Such simple power state selection logic may provide significant power savings that may be sufficient for certain embodiments, such as implementations where significant deviations from the substantially predetermined pattern are infrequent.

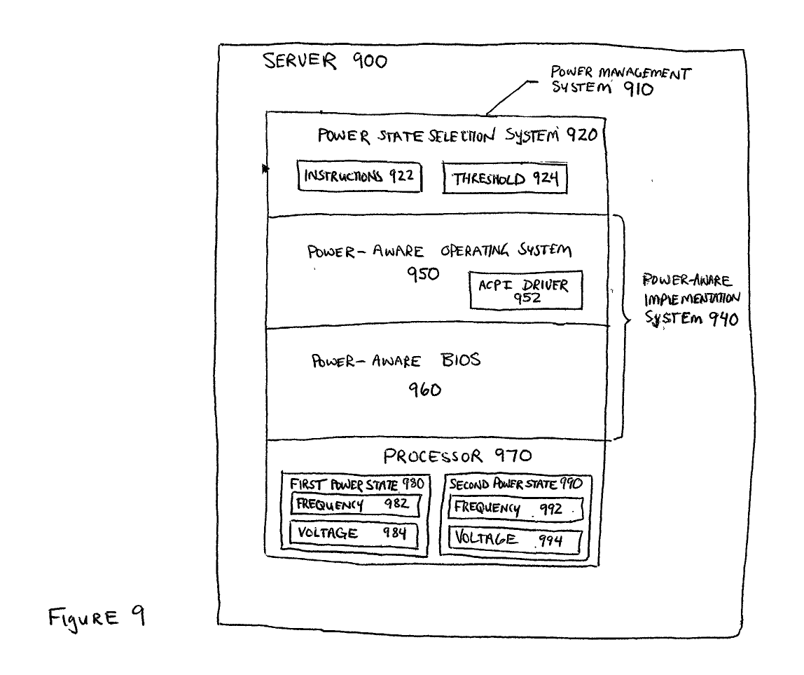

FIG. 9 shows simplified system architecture of a power management system 910 of a server 900, according to one embodiment. The power management system 910 comprises a power state selection system 920 to select a power state, a power-aware implementation system 940 coupled with the selection system 920 to implement the selected power state, and a processor 970 coupled with the implementation system 940 to switch to the implemented power state and operate in that state.

The power state selection system 920, which may be an application, comprises power state selection instructions 922 and a threshold 924. The system 920 uses the instructions and the threshold 924 and information associated with load received from a network, such as network 210, to select a power state. After selecting a power state the system 920 provides a power state selection signal to the implementation system 940.

The power-aware implementation system 940 receives the power state selection signal and implements the signal on the processor 970 via a power state implementation signal. The term “power-aware” is used to broadly designate that the hardware interface supports the first power state 980 and the second power state 990 and comprises logic to implement the processor 970 alternatively in either of the states 980 or 990 based on the selection from the selection system 920. According to one embodiment, the implementation system 940 implements according to Advanced Configuration And Power Interface (ACPI) specification version 2.0.

According to one embodiment, the power aware implementation system 940 comprises a power-aware operating system 950 and a power aware BIOS 960. The operating system 950 may be a software application operable to be executed on the server 900 to provide an interface between applications, such as the selection system 920, and the BIOS 960. The operating system supports the first operating power state 980 and the second operational power state 990. The operating system 950 may provide operating system directed power management. The operating system 950 may support ACPI version 2.0 and may control and implement power states on the processor 970, and other desired hardware, based on user settings and application requests, such as power state selection signals from the power state selection system 920. The operating system 950 may comprise an ACPI driver 952 to assist with placing the processor 970 in one of the power states 980 or 990. The driver 952 may wait for ACPI events such as power state selection signals to occur. According to one embodiment, the operating system 950 may comprise a server Windows, Unix, Linux, Sun Solaris, Macintosh, or other operating system. For example, the operating system may comprise Microsoft Windows NT Server 4.0, available from Microsoft Corporation of Redmond, Wash.

The power-aware BIOS is able to implement the first power state 980 or the second power state 990 on the processor 970. According to one embodiment, the BIOS supports ACPI version 2.0. Such a BIOS 960 is well-known to a person having an ordinary level of skill in the art and thus will not be discussed further. The BIOS 960 provides a power state implementation signal to the processor 970.

The processor 970 receives the power state implementation signal and switches to the indicated power state. According to one embodiment, the first power state comprises a frequency 982 and a voltage 984 and the second power state 990 comprises a different frequency 992 and a different voltage 994.

Mobile Intel® Pentium® III Processor-M Example

Consider without limitation a specific embodiment wherein the processor 970 is a Mobile Intel® Pentium® III Processor-M and wherein the power-aware implementation system 940 comprises an Intel® 815EM chipset, BIOS, voltage regulator, and Windows NT operating system that each support Intel® SpeedStep™ Technology, an Intel® SpeedStep™ Technology Control Logic control logic ASIC coupled between the chipset and the processor 970, and an Intel® SpeedStep™ Technology driver.

The first state 980 may be a low power state comprising a frequency 982 of 733 MHz and a voltage 984 of 1.15 V. The second state 990 may be a high power state comprising a frequency 992 of 1133 MHz and a voltage 994 of 1.40 V. Other frequencies and voltages are also contemplated as will be apparent to a person having an ordinary level of skill in the art and the benefit of the present disclosure. Without limitation, transition between these states may affect the power proportional to the change in frequency and proportional to the square of the change in voltage.

The selection system 920 provides a power state selection signal that is operable to be recognized by the implementation system 940. According to one embodiment, the signal may substantially mimic a signal currently used in laptop implementations where Intel® SpeedStep™ Technology is used to implement a maximum performance mode or a battery power mode on a laptop based on whether the laptop is plugged in or using battery power. For example, it may comprise a conventional voltage asserted on a pin coupled with an external power source. In another embodiment, the power state selection may comprise information indicating a voltage and frequency pair 982, 984 or 992, 994, information indicating a bus clock ratio of one of the states 980 or 990, or information corresponding to a frequency multiplier of one of the states 980 or 990. For example, the signal may comprise an indication of a 5-bit code corresponding to a bus ratio stored in a power-on configuration register.

The power state implementation system 940 processes the power state selection signal into a power state implementation signal suitable to implement the power state on the processor 970. According to a first embodiment the implementation signal indicates a bus ratio for one of the states 980 or 990. According to a second embodiment, the implementation signal comprises an Intel® SpeedStep™ Technology operating mode selection GHI# signal that corresponds to a bus clock ratio of either the first state 980 or the second state 990 and that has been pre-programmed into the processor 970 during manufacturing. According to a third embodiment, the implementation signal is a signal to switch the processor 970 to a higher power state 980 and comprises signals to put the processor 970 into a low power Deep Sleep state, raise the core voltage, set GHI# low, and return to the Normal state. This may allow switching the processor 970 between states 980 and 990 in real time without reset and without changing system bus frequency. According to a fourth embodiment, the implementation signal is a signal to switch the processor 970 back to the initial lower power state to reduce power consumption and comprises signals corresponding to a substantial reversal of the described operations.

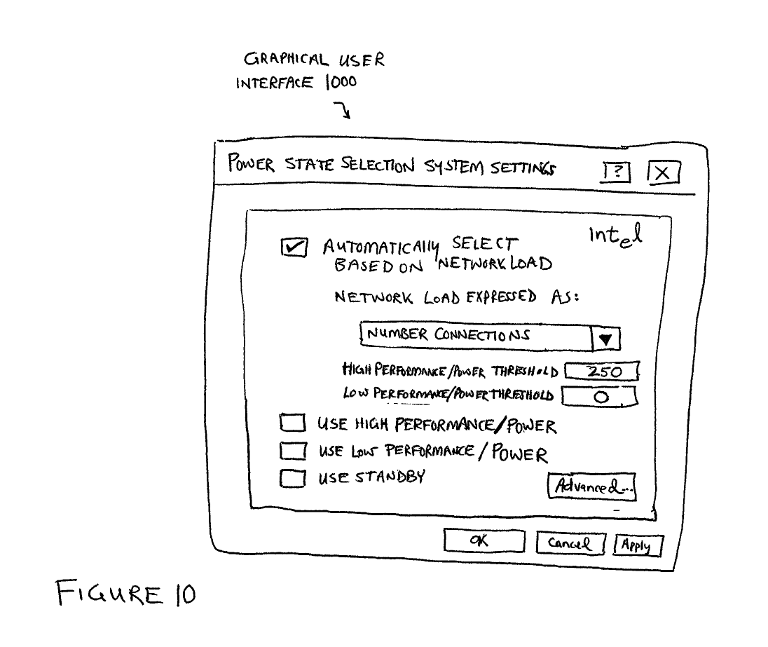

FIG. 10 shows a graphical user interface 1000 to allow a user to specify power state selection system settings and parameters, according to one embodiment. The GUI 1000 may be provided by an applet or other software means. The GUI 1000 allows a user to configure the selection system to automatically select a power state based on network load, to override to use a high performance/high power mode, to override to use a low performance/low power mode, or to override to use a standby mode. Without limitation, the automatic mode has been selected. The GUI 1000 also allows selection of different predetermined network load representations that are available from a pull-down menu. Without limitation number of active connections has been selected. The GUI 1000 also provides fields to enter each of a high performance/power state threshold and a low performance/power state threshold, in this case minimum number of connections to use for the high performance/power state and low performance/power state, respectively. Without limitation the high threshold has been set at 250 and the low threshold has been set at 0. Other settings of the power state selection system may be made via an advanced settings menu.

Alternate Embodiments

Many alternate embodiments are contemplated. Exemplary alternate embodiments are discussed below, although other embodiments will be appreciated by a person having an ordinary level of skill in the art based on the present disclosure.

Operating System To Select A Power State

According to a first alternate embodiment, an operating system may incorporate a power state selection system and its method of selecting a power state based on at least a representation of a network load.

Multiprocessing Implementation

According to a second alternate embodiment, the power state selection system may be used to select a power state for one or more processors in a processor farm, a server farm, a rack mount server, or other multiprocessor environment. In a first embodiment, the power state selection system may select a power state for an individual processor. In this case the power state selection signal may indicate the individual processor. In a second embodiment, the power state selection system may select a power state for a plurality of processors. In this case the power state selection signal may indicate the plurality of processors, or if the plurality comprises less than all of the available processors, the power state selection signal may indicate particular processors of the plurality.

Exemplary Computer Architecture

As discussed herein, a “system” or “computer system” , such as a computer system having a power state selection system, may be an apparatus including hardware and/or software for processing data. The system may include, but is not limited to a network connected computer (e.g., server, mainframe, etc.), or other system (e.g., fax machine, printer, etc.).

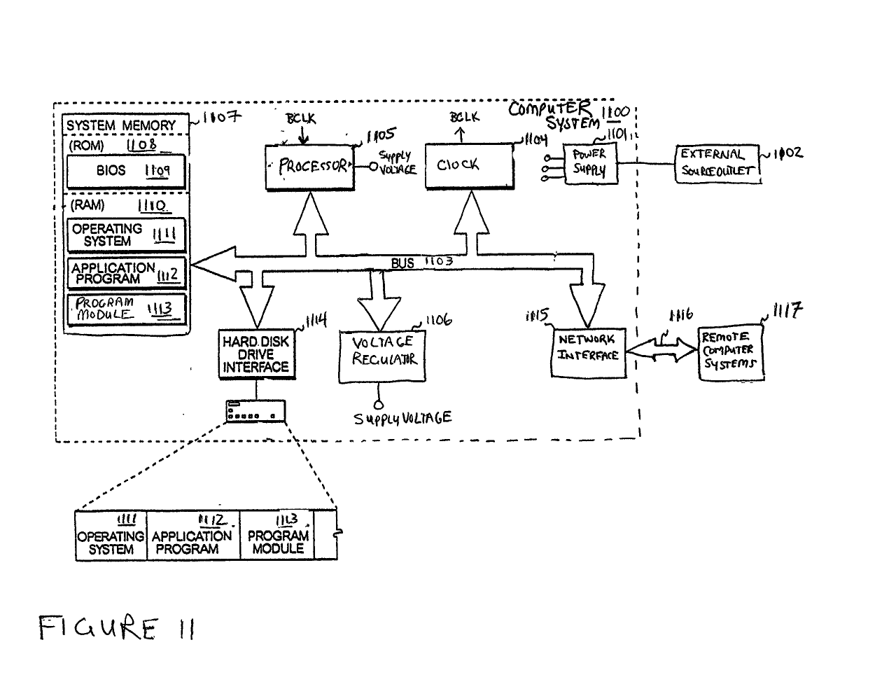

A computer system 1100 representing an exemplary networked computer system, host, or server in which features of the invention may be implemented will now be described with reference to FIG. 11. The computer system 1100 represents one possible computer system for implementing embodiments of the invention, however other computer systems and variations of the computer system 1100 are also contemplated.

The computer system 1100 comprises a power supply 1101 to receive power from an external source outlet 1102 and to provide power to components of the system 1100. The components include a bus or other communication means 1103 to communicate information, a clock 1104 to provide a BCLK, a processing means such as processor 1105 coupled with the bus 1103 to receive the BCLK and supply voltage from a voltage regulator 1106 and to process information in different power consuming states.

The system 1100 further comprises a system memory 1107 coupled with the bus 1103 that includes a read only memory (ROM) 1108 to store static information and instructions for the processor 1105, such as a power-aware BIOS 1109, and a random access memory (RAM) 1110 to store dynamic information and instructions to be executed by the processor 1105. The RAM 1110 may be used to store temporary information during execution of instructions by the processor 1105. In one embodiment, the RAM 1110 may be used to store a power-aware operating system 1111, an application program 1112, and a program module 1113. The application program 1112, the program module 1113, or both may be used to implement certain power management features of the invention, such as power state selection, and implementation (e.g., a power driver). The operating system 1111, application program 1112 and program module 1113 may be accessed via a hard disk drive interface 1114, according to one embodiment.

The system 1100 may also comprise a network interface 1115 to interface with a network 1116 and interact with a plurality of remote computer systems 1117. Depending upon the particular implementation, the communication device 1115 may include a modem, a network interface card, or other well-known interface devices, such as those used for coupling to Ethernet, token ring, or other types of physical attachment for purposes of providing a communication link to a network.

Those having an ordinary level of skill in the art will appreciate that the system 1100 may comprise other components that are not shown. For example, the system 1100 may have a user interface or console comprising a display device (e.g., a monitor), a data input device (e.g., a keyboard or a cursor control device).

The present invention includes various methods and operations as described above. The methods of the invention may be performed by hardware, software, or a combination. Aspects of the invention may be embodied in machine-executable instructions that if executed cause a semiconductor logic product, circuit, or processor programmed with the instructions to perform the operations. The present invention may be provided as a computer program product that may include a machine-readable medium having stored thereon instructions that if executed may program a computer system to perform processes according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media or machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

In conclusion, the present invention provides an approach for selecting a power state for a network computer system based on a network load.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

[image]

[image]

What is claimed is:

1. A computer system comprising: a network interface coupled with a network to receive an increased network load comprising load portions for each of an increased plurality of connections with electronic network access devices;
a power state selection system coupled with the network interface to receive at least a representation of the increased network load, to select a higher power state that consumes more power by comparing the representation with a predetermined threshold to determine that the representation is greater than the threshold, and to assert a power state selection signal that corresponds to the higher power state;
a power state implementation system coupled with the power state selection system to receive the asserted power state selection signal and to assert a corresponding power state implementation signal;
a processor coupled with the power state implementation system to receive the power state implementation signal, to switch to the higher power state, and to execute operations associated with the receive network load at the higher power state; and
a power source coupled with the computer system to supply an increased amount of power to the computer system to power the processor in the higher power state.

2. The computer system of claim 1:
wherein the increased network load comprises a load portion for an un-secured connection and a load portion for a secured connection; and
wherein the representation comprises a representation portion for the unsecured connection and a larger representation portion for the secured connection.

3. The computer system of claim 1, wherein the power state selection system comprises a plurality of preprogrammed thresholds that each correspond to a predetermined operational power state for the processor.

4. A computer system comprising:
a network interface coupled with a network to receive a network processing load associated with a plurality of network access devices;
a power management system coupled with the network interface to receive a representation of the network processing load, to select a power state of a plurality of operational power states based on the representation, and to assert the power state;
hardware having the plurality of operational power states coupled with the power management system to receive the asserted power state, to switch to the asserted power state, to receive an amount of power that depends on the asserted power state from a power source, and to execute operations associated with the received network load at the asserted power state.

5. The computer system of claim 4:
wherein the computer system is a server;
wherein the power management system comprises:
a power state selection system coupled with the network interface to receive the representation, to select the power state by comparing the representation with a threshold, and to assert a power state selection signal; and
a power state implementation system coupled with the power state selection system to receive the power state selection signal and to assert a power state implementation signal; and
wherein the hardware comprises a processor coupled with the power state implementation system to receive the asserted power state implementation signal, to switch to the asserted power state, to receive an amount of power that depends on the power state from a non-battery power source, and to execute operations associated with the received network load at the power state.

6. The computer system of claim 4:
wherein the hardware comprises a processor having a plurality of predetermined operational power states that each have a different core operating frequency; and
wherein the power management system is operable to select one of the plurality of predetermined operational power states for the processor and to implement the selected power state on the hardware.

7. The computer system of claim 6, wherein the processor comprises a laptop processor.

8. The computer system of claim 4, wherein the hardware comprises a processor having a high power state that has a high operational clock frequency and a low power state that has a low operational clock frequency.

9. A power state selection system to receive a representation of a network processing load associated with a plurality of network access devices, to select a power state based on the representation, and to assert a power state selection signal corresponding to the selected power state.

10. The power state selection system of claim 9, wherein the representation of the network processing load comprises an indication of a number of client connections.

11. The power state selection system of claim 9, wherein the representation of the network processing load comprises an indication of an activity of a processor.

12. The power state selection system of claim 9, further comprising logic to select by comparing the representation with a predetermined threshold.

13. The power state selection system of claim 9, wherein the power state selection signal identifies a bus ratio selection signal corresponding to a predetermined bus ratio of a processor.

14. The power state selection system of claim 9, further comprising:
a power state implementation system coupled with the power state selection system to receive the power state selection signal and to assert a power state implementation signal; and
hardware coupled with the power state implementation system to receive the power state implementation signal and to switch to a power state corresponding to the power state implementation signal.

15. The power state selection system of claim 14:
wherein the power state implementation system comprises an Advanced Configuration And Power Interface power state implementation system; and
wherein the hardware comprises a processor to switch from a first operational power state comprising a first core voltage and a first core frequency to a second operational power state comprising a second core voltage that is different than the first and a second core frequency that is different than the first.

16. A power state selection system to direct a processor of a server into one of a plurality of executing power consuming states based on a change in processing load received from a network that comprises a changed number of connections from client network access devices.

17. The power state selection system of claim 16, implemented as a software application communicatively coupled with an operating system that directs power management.

18. The power state selection system of claim 16, implemented as a software application communicatively coupled with an Advanced Configuration And Power Interface power driver for the processor.

19. The power state selection system of claim 16, implemented as logic within a server operating system.

20. A method comprising:
receiving a network processing load corresponding to a plurality of clients from a network;
selecting a higher power state for a processor by comparing a representation of the network processing load with a predetermined threshold and determining that the representation is greater than the threshold; and
asserting a power state selection signal that indicates the selected higher power state.

21. The method of claim 20, further comprising, before asserting determining whether the selected power state is different than a current power state.

22. A processor to be placed in the higher power state by the method of claim 20.

23. A machine-readable medium having stored thereon data representing instructions that if executed cause a machine to:
receive a processing load from a plurality of networked clients;
select a lower power state for hardware by comparing a representation of the load with a predetermined threshold to determine that the representation is lower than the threshold; and
assert a power state selection signal corresponding to the selected power state.

24. The machine-readable medium of claim 23, wherein the instructions to select further comprise instructions that if executed cause the machine to select a predetermined operational power state for a processor of the hardware.

25. The machine-readable medium of claim 23, wherein the instructions to assert further comprise instructions that if executed cause the machine to assert a power state selection signal operable to cause an Advanced Configuration And Power Interface implementation system to implement the selected power state on a processor of the hardware.
